(19) United States
(12) Patent Application Publication
(10) Pub. No.: US 2016/0285537 A1
(43) Pub. Date: Sep. 29, 2016

(54) System and Method for Multi-Mode Multi-Spectrum Relays

(71) Applicant: Huawei Technologies Co., Ltd., Shenzhen (CN)

(72) Inventors: Amine Maaref, Kanata (CA); Mohamed Adel Salem, Kanata (CA); Jianglei Ma, Ottawa (CA)

(21) Appl. No.: 14/670,148

(22) Filed: Mar. 26, 2015

(51) Int. Cl. H04B 7/14; H04W 28/02; H04W 72/04; H04L 5/00; H04W 16/14

(52) U.S. Cl. CPC H04B 7/14; H04L 5/0055; H04W 16/14; H04W 72/0453; H04W 28/0268; H04W 88/02

(57) ABSTRACT

Multi-spectrum relays may improve the throughput and resource utilization of networks by relaying data from a transmit point to a receive point using both licensed and unlicensed spectrum. A multi-spectrum relay may receive data from the transmit point on one band, and relay the data to the receive point on another band. The multi-spectrum relay may cache data for re-transmission. Various frequency allocation schemes may be used to leverage the capabilities of multi-spectrum relays. When the complementary band includes higher frequencies than the primary band, access links between a base station and cell-edge users may carry wireless transmissions over the primary band, while access links between relays and cell-edge users may carry wireless transmissions over the complementary band.

### TECHNICAL FIELD

The present invention relates generally to telecommunications, and in particular embodiments, to systems and methods for multi-mode multi-spectrum relays.

### BACKGROUND

Governmental bodies reserve bands of wireless spectrum for different uses. For example, the Federal Communications Commission (FCC), the International Telecommunication Union (ITU), and other regulatory agencies reserve some portions of the spectrum for licensed activities (e.g., radio, television, satellite, mobile telecommunication, etc.), while reserving other portions of the spectrum for unlicensed activities. The licensed spectrums may be subject to regulations set forth by the regulatory agency, as well as to operating protocols agreed upon by the public and/or private entities engaging in the licensed activity. The spectrum reserved for unlicensed communications may also be subject to regulations set forth by the corresponding regulatory agency, particularly with regards to transmission power and shared access.

### SUMMARY OF THE INVENTION

Technical advantages are generally achieved, by embodiments of this disclosure which describe systems and methods for multi-mode multi-spectrum relays.

In accordance with an embodiment, a method for operating a multi-spectrum relay is provided. In this example, the method includes establishing a first wireless link between a relay station and a transmit point, establishing a second wireless link between the relay station and a receive point, and relaying data from the transmit point to the receive point over the first wireless link and the second wireless link using both licensed and unlicensed spectrum. Relaying data from the transmit point to the receive point using both licensed and unlicensed spectrum comprises communicating a first wireless signal that at least partially spans a primary band and a second wireless signal that at least partially spans a complementary band. The primary band is licensed for cellular communication, and the complementary band is reserved for unlicensed communication. An apparatus for performing this method is also provided.

In accordance with another embodiment, a method for operating a multi-spectrum relay is provided. In this example, the method comprises establishing a wireless link between a relay station and a receive point, and wirelessly receiving a data packet from a transmit point at the relay station. The data packet is addressed to the receive point. The method further includes transmitting the data packet to the receive point over the wireless link. Transmitting the data packet over the wireless link comprises transmitting the data packet over a primary band licensed for cellular communications when a first criteria is satisfied, and transmitting the data packet over a complementary band reserved for unlicensed communications when a second criteria is satisfied. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIGS. 2A-2C illustrate diagrams of embodiment bandwidth allocation schemes for multi-spectrum relay networks;

FIGS. 3A-3K illustrate diagrams of additional embodiment bandwidth allocation schemes for multi-spectrum relay networks;

FIG. 4 illustrates a diagram of an embodiment network for relaying data over primary and complementary spectrum bands;

FIG. 5 illustrates a diagram of another embodiment bandwidth allocation scheme for the network depicted in FIG. 4;

FIG. 6 illustrates a diagram of an embodiment network for relaying data over primary and complementary spectrum bands;

FIG. 7 illustrates a diagram of an embodiment bandwidth allocation scheme for the network depicted in FIG. 6;

FIG. 8 illustrates a diagram of another embodiment network for relaying data over primary and complementary spectrum bands;

FIG. 9 illustrates a diagram of an embodiment bandwidth allocation scheme for the network depicted in FIG. 8;

FIG. 10 illustrates a flowchart of an embodiment method for relaying data over licensed and unlicensed bands;

FIG. 11 illustrates a flowchart of another embodiment method for relaying data over licensed and unlicensed bands;

FIG. 12 illustrates a flowchart of an embodiment method for scheduling data over licensed and unlicensed bands;

FIG. 13 illustrates a flowchart of an embodiment method for dynamically forwarding downlink traffic over direct and indirect paths of a multi-spectrum relay network via wireless transmissions spanning licensed and unlicensed spectrum;

FIG. 14 illustrates a diagram of an embodiment computing platform; and

FIG. 15 illustrates a diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Many wireless telecommunication protocols, such as the long term evolution (LTE) advanced (LTE-A) protocol, operate exclusively in frequency bands licensed for cellular communications, which are collectively referred to as the “primary band” throughout this disclosure. Other wireless telecommunications protocols, such as Wi-Fi protocol, operate exclusively in the unlicensed band, which is referred to as the “complementary band” throughout this disclosure. The term “licensed band” may be used interchangeably with the term “primary band,” and the term “unlicensed band” may be used interchangeably with the term “complementary band.” Notably, the frequency bands licensed for cellular transmission may change from time to time, and the term “primary band” may also refer to frequency bands that are re-licensed for cellular transmission after the filing of this application. The complementary band may include spectrums reserved for non-telecom purposes, such as the industrial, scientific and medical (ISM) band. Telecommunication protocols operating over the primary band often provide more reliable data transmissions, while telecommunication protocols operating over the complementary band are often capable of supporting low latency high volume transmissions, albeit with reduced reliability.

A unified air interface configured to transport wireless transmissions spanning portions of both the primary and complementary bands is described in U.S. patent application Ser. No. 14/669,333 (Att. Docket. No. HW 91017895US502), which is incorporated by reference herein as if reproduced in its entirety. Aspects of this disclosure extend that unified air interface to multi-spectrum relays to improve the throughput and resource utilization of those systems. Specifically, a multi-spectrum relay may relay data from a transmit point to a receive point using both licensed and unlicensed spectrum. In one embodiment, the multi-spectrum relay receives data from the transmit point on one band, and relays the data to the receive point on another band. For example, the multi-spectrum relay may receive a wireless transmission from the transmit point on the primary band, and relay the wireless transmission to the receive point on the complementary band, or vice versa. In some embodiments, the multi-spectrum relay caches data for re-transmission. For example, the relay may cache a downlink wireless transmission communicated from a base station over the primary band, and forward the downlink transmission over the complementary band upon determining that a UE did not successfully decode the downlink transmission or upon receiving an instruction from the base station to send the cached data. The relay may determine whether the UE successfully decoded an original downlink transmission based on ACK/NACK signaling communicated by the UE. The ACK/NACK signaling may be communicated to the relay station directly or over an end-to-end access link extending between the UE and the base station. The ACK signaling may be communicated in the primary band, the complementary band, or combinations thereof. Similar procedures can be used for any receive point that communicates ACK/NACK (or similar) signaling.

Aspects of this disclosure also provide various frequency allocation schemes for multi-spectrum relay networks. The allocation schemes may depend, inter alia, on whether the complementary band comprises higher frequencies, or lower frequencies, than the primary band, as lower frequencies tend to have lower attenuation rates than higher frequencies, therefore allowing wireless transmissions over lower frequencies to have an extended range. In one embodiment, the complementary band includes higher frequencies than the primary band. In such an embodiment, access links between a base station and cell-edge users may carry wireless transmissions over the primary band, and access links between relays and cell-edge users may carry wireless transmissions over the complementary band. In another embodiment, the complementary band includes lower frequencies than the primary band. In such an embodiment, access links between a base station and cell-edge users may carry wireless transmissions over the complementary band, and access links between relays and cell-edge users may carry wireless transmissions over the primary band. These and other details are explained in greater detail below.

As used herein, the term “unified air interface” refers to an air interface sharing a common physical and medium access control (MAC) connection, as may be consistent with an interface operating in accordance with a common radio access technology (RAT), such as a cellular radio access network (RAN) in an fifth generation (5G) LTE system. In some embodiments, a unified air interface includes at least two spectrum-type dependent air interface configurations, including one air interface configuration for a primary band licensed for cellular communication, and one air interface configuration for a complementary band reserved for unlicensed communication.

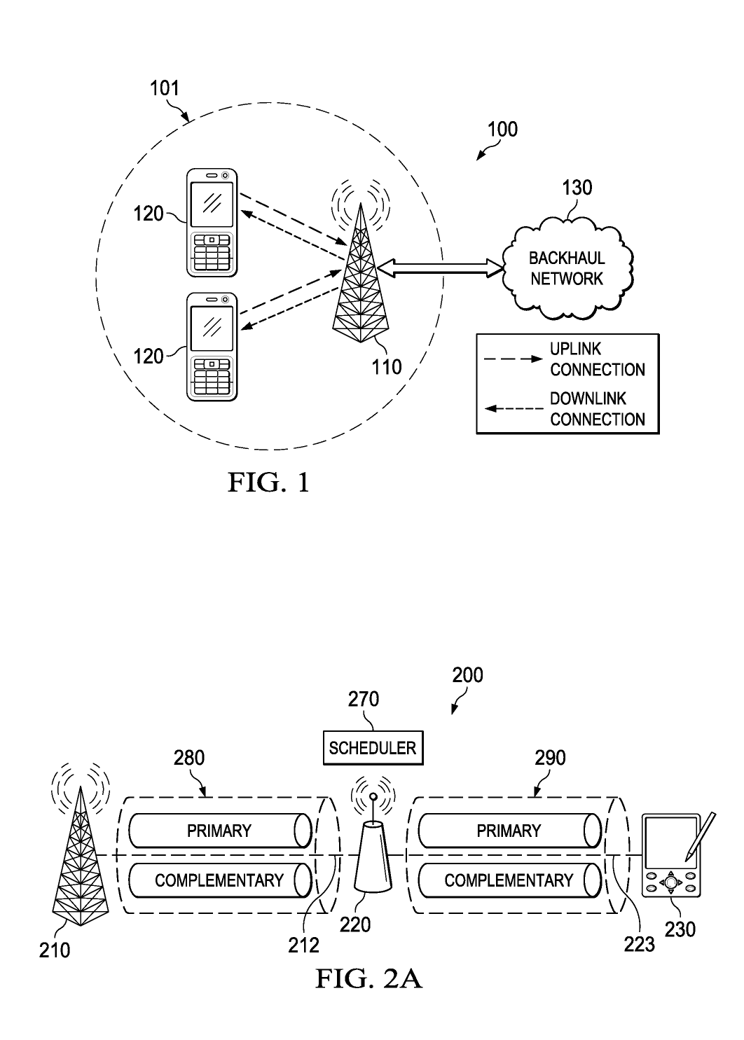

FIG. 1 illustrates a network 100 for communicating data. The network 100 comprises a base station 110 having a coverage area 101, a plurality of mobile devices 120, and a backhaul network 130. As shown, the base station 110 establishes uplink (dashed line) and/or downlink (dotted line) connections with the mobile devices 120, which serve to carry data from the mobile devices 120 to the base station 110 and vice-versa. Data carried over the uplink/downlink connections may include data communicated between the mobile devices 120, as well as data communicated to/from a remote-end (not shown) by way of the backhaul network 130. As used herein, the term “base station” refers to any component (or collection of components) configured to provide wireless access to a network, such as an enhanced base station (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network 100 may comprise various other wireless devices, such as relays, low power nodes, etc.

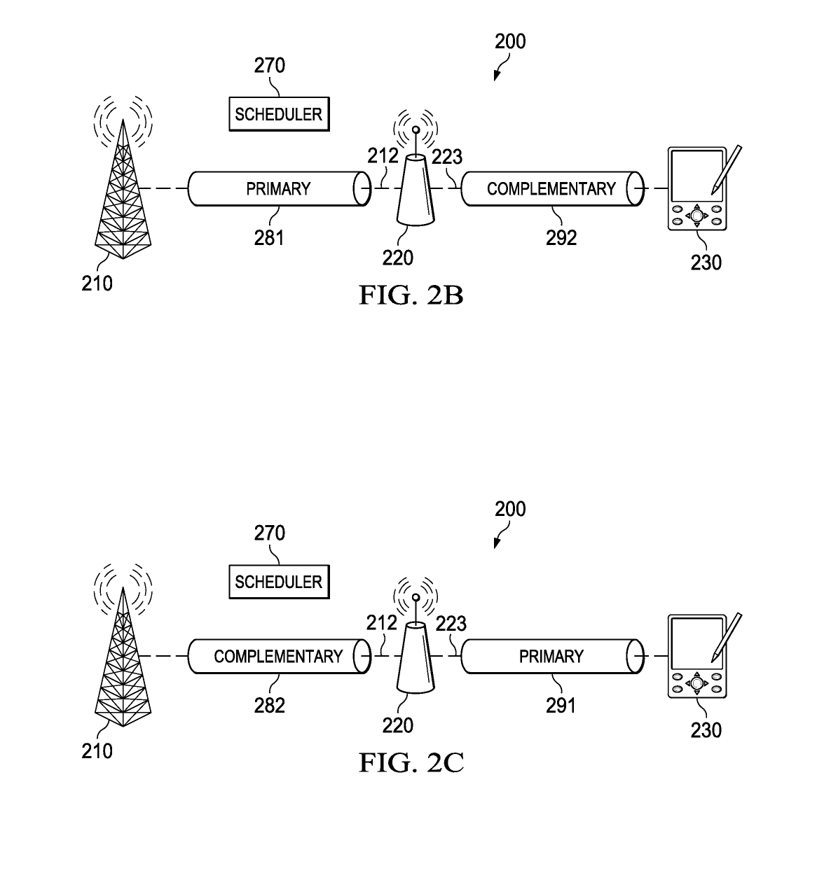

Unified air interfaces configured to transport wireless transmissions spanning portions of both the primary and complementary spectrums are discussed in U.S. patent application Ser. No. 14/669,333 (Att. Docket. HW 91017895US502), which is incorporated by reference herein as if reproduced in its entirety. Aspects of this disclosure extend the concept of communicating over both primary and complementary bands to systems deploying multi-spectrum relays. FIGS. 2A-2C illustrate embodiment bandwidth allocation schemes for multi-spectrum relay networks. FIG. 2A illustrates an embodiment multi-spectrum relay network 200 comprising a base station 210, a multi-spectrum relay station 220, a UE 230, and a scheduler 270. As shown, a backhaul link 212 is established between the base station 210 and the multi-spectrum relay station 220, and an access link 223 is established between the multi-spectrum relay station 220 and the user equipment 230. In this example, both of the links 212, 223 are configured as unified air interfaces, and carry wireless transmissions 280, 290 that span portions of both the primary band and the complementary band.

In some embodiments, the multi-spectrum relay station 220 may utilize different bands over different links. For example, the multi-spectrum relay station 220 may communicate a wireless signal 281 spanning the primary band over the backhaul link 212, while communicating a wireless signal 292 spanning the complementary band over the access link 223, as demonstrated by FIG. 2B. Conversely, the multi-spectrum relay station 220 may communicate a wireless signal 282 spanning the complementary band over the backhaul link 212, while communicating a wireless signal 291 spanning the primary band over the access link 223, as demonstrated by FIG. 2C. Other combinations are also available. For example, the multi-spectrum relay station 220 may communicate a dual-spectrum signal (e.g., the wireless transmission 280) over the backhaul link 212, while communicating a single-spectrum signal (e.g., the wireless transmission 291 or the wireless transmission 292) over the access link 223. As another example, the multi-spectrum relay station 220 may communicate a single-spectrum signal (e.g., the wireless transmission 281 or the wireless transmission 282) over the backhaul link 212, while communicating a dual-spectrum signal (e.g., the wireless transmission 290) over the access link 223.

The scheduler 270 may be a control plane entity adapted to schedule traffic over the backhaul link 212 and/or the access link 223. In some embodiments, the scheduler 270 is an integrated component on the base station 210. In other embodiments, the scheduler 270 is independent from the base station 210. In some embodiments, the scheduler 270 schedule traffic having deterministic QoS constraints to be transported over the primary band, and schedules traffic having statistical QoS constraints to be transported over the complementary band when the complementary band is capable of satisfying the statistical QoS constraint of the traffic. As discussed herein, a “deterministic QoS constraint” requires that every packet in a traffic flow be communicated in a manner that satisfies a QoS requirement, while a “statistical QoS constraint” can be satisfied even if some packets (e.g., a fraction of the total packets) are communicated in a manner that violates a QoS requirement. For example, a deterministic latency requirement is satisfied when each packet in the flow is communicated within a delay bound. Conversely, a statistical latency requirement may be satisfied when a certain percentage of the packets are communicated within a delay bound.

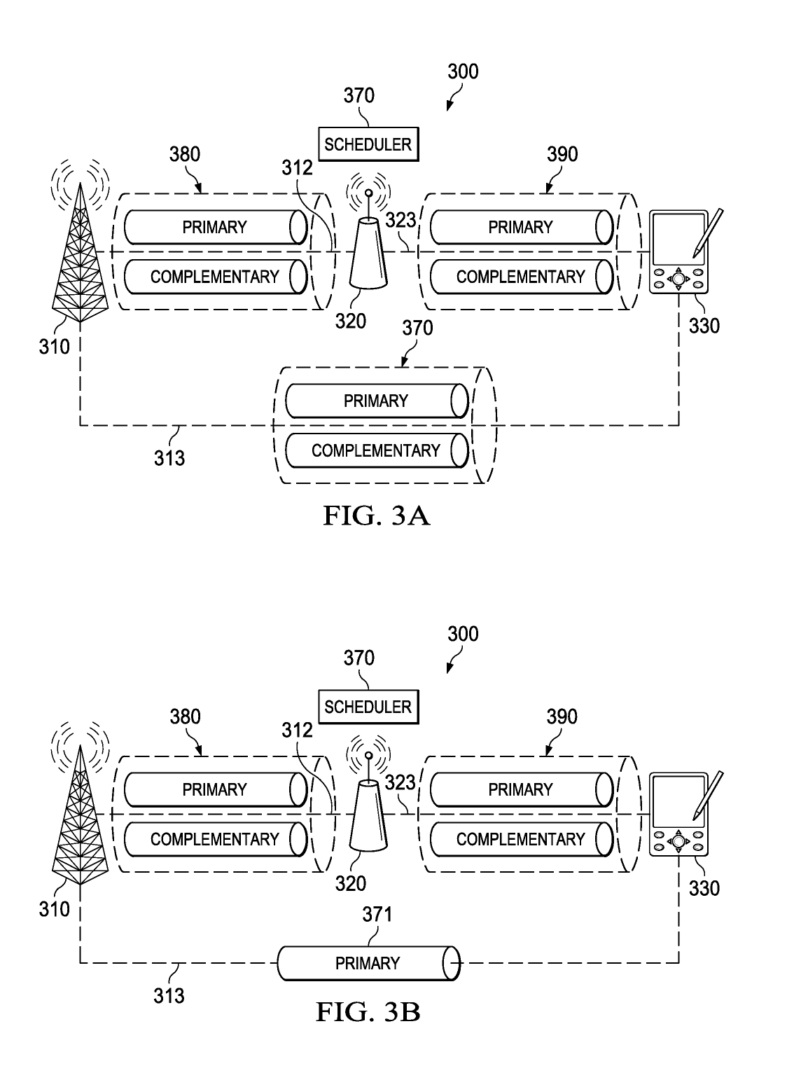

In some embodiments, multi-spectrum relay networks may include end-to-end access links between the transmit point and the receive point. FIGS. 3A-3K illustrate embodiment bandwidth allocation schemes for multi-spectrum relay networks that include end-to-end access links.

FIG. 3A illustrates an embodiment wireless network 300 adapted for multi-spectrum relaying of data between transmit and receive points. As shown, the wireless network 300 comprises a base station 310, a multi-spectrum relay station 320, a UE 330, and a scheduler 370. A backhaul link 312 is established between the base station 310 and the relay station 320, an access link 323 is established between the relay station 320 and the user equipment 330, and an end-to-end access link 313 is established between the base station 320 and the UE 330. In this example, each of the end-to-end access link 313, the backhaul link 312, and the access link 323 carry wireless transmissions 270, 280, 290 (respectively) that span portions of both the primary band and the complementary band.

In other embodiments, the end-to-end access link 313 may be configured to carry a single-spectrum signal, while the backhaul links 312 and the access link 323 are configured to transport dual-spectrum signals. For example, the end-to-end access link 313 may transport a single-spectrum wireless signal 371 over the primary band, while the backhaul link 312 and the access link 323 transport multi-spectrum wireless signals 380, 390 (respectively), as demonstrated by FIG. 3B. As another example, the end-to-end access link 313 may transport a single-spectrum wireless signal 372 over the complementary band, while the backhaul link 312 and the access link 323 transport multi-spectrum wireless signals 380, 390 (respectively), as demonstrated by FIG. 3C.

In other embodiments, the access link 323 and the end-to-end access 313 link may carry single-spectrum signals over different bands. For example, the end-to-end access link 313 may transport a single-spectrum wireless signal 371 over the primary band, while the access link 323 transports a single-spectrum wireless signal 392 over the complementary band, as demonstrated by FIG. 3D. As another example, the end-to-end access link 313 may transport a single-spectrum wireless signal 372 over the complementary band, while the access link 323 may transport a single-spectrum wireless signal 391 over the primary band, as demonstrated by FIG. 3E. In such embodiments, the wireless backhaul link 312 may be adapted to carry a dual-spectrum signal spanning both the primary and complimentary bands, a single spectrum signal communicated exclusively over the primary band, or a single spectrum signal communicated exclusively over the complementary band.

In other embodiments, the access link 323 and the end-to-end access link may carry single-spectrum signals over the same band, which may be beneficial, inter alia, in instances when the UE 330 is not enabled with multi-spectrum capability. In one embodiment, the end-to-end access link 313 and the access link 323 transport single-spectrum wireless signals 371, 391 over the primary band, as demonstrated by FIG. 3F. In this embodiment, the backhaul link 312 is adapted to transport a signal 383 that at least partially spans the complementary band. For example, the wireless signal 383 may be a single-spectrum signal communicated exclusively in the complementary band, or a dual-spectrum signal spanning both the primary and complementary bands. In another embodiment, the end-to-end access link 313 and the access link 323 transport single-spectrum wireless signals 372, 392 over the complementary band, as demonstrated by FIG. 3G. In this embodiment, the backhaul link 312 is adapted to transport a signal 384 that at least partially spans the primary band. For example, the wireless signal 383 may be a single-spectrum signal communicated exclusively in the primary band, or a dual-spectrum signal spanning both the primary and complementary bands.

In other embodiments, the backhaul link 312 and the end-to-end access 313 link may carry single-spectrum signals over different bands. For example, the end-to-end access link 313 may transport a single-spectrum wireless signal 371 over the primary band, while the backhaul link 312 transports a single-spectrum wireless signal 382 over the complementary band, as demonstrated by FIG. 3H. As another example, the end-to-end access link 313 may transport a single-spectrum wireless signal 372 over the complementary band, while the backhaul link 312 transports a single-spectrum wireless signal 381 over the primary band, as demonstrated by FIG. 3I. In such embodiments, the backhaul link 312 may be adapted to carry a dual-spectrum signal spanning both the primary and complimentary bands, or a single spectrum signal communicated exclusively over either the primary band or the complementary band.

In yet other embodiments, the backhaul link 312 and the end-to-end access 313 link may carry single-spectrum signals over the same band. In one embodiment, the end-to-end access link 313 and the backhaul link 312 transport single-spectrum wireless signals 371, 381 over the primary band, as demonstrated by FIG. 3J. In this embodiment, the access link 323 is adapted to transport a signal 393 that at least partially spans the complementary band, e.g., a single-spectrum signal communicated exclusively in the complementary band, or a dual-spectrum signal spanning both the primary and complementary bands. In another embodiment, the end-to-end access link 313 and the backhaul link 312 transport single-spectrum wireless signals 372, 382 over the complementary band, as demonstrated by FIG. 3K. In this embodiment, the backhaul link 312 is adapted to transport a signal 394 that at least partially spans the primary band, e.g., a single-spectrum signal communicated exclusively in the primary band, a dual-spectrum signal spanning both the primary and complementary bands, etc.

Different spectrum bands may have different propagation properties, and consequently may yield relative coverage regions having different sizes. For example, the primary band may provide a comparatively larger coverage region than the complementary band when the complementary band includes higher carrier frequencies than the primary band. In such instances, the multi-spectrum relays can be used to compensate for coverage holes induced by different footprints of primary and complementary spectrum bands thereby allowing smooth coverage and operation for 5G-U technology

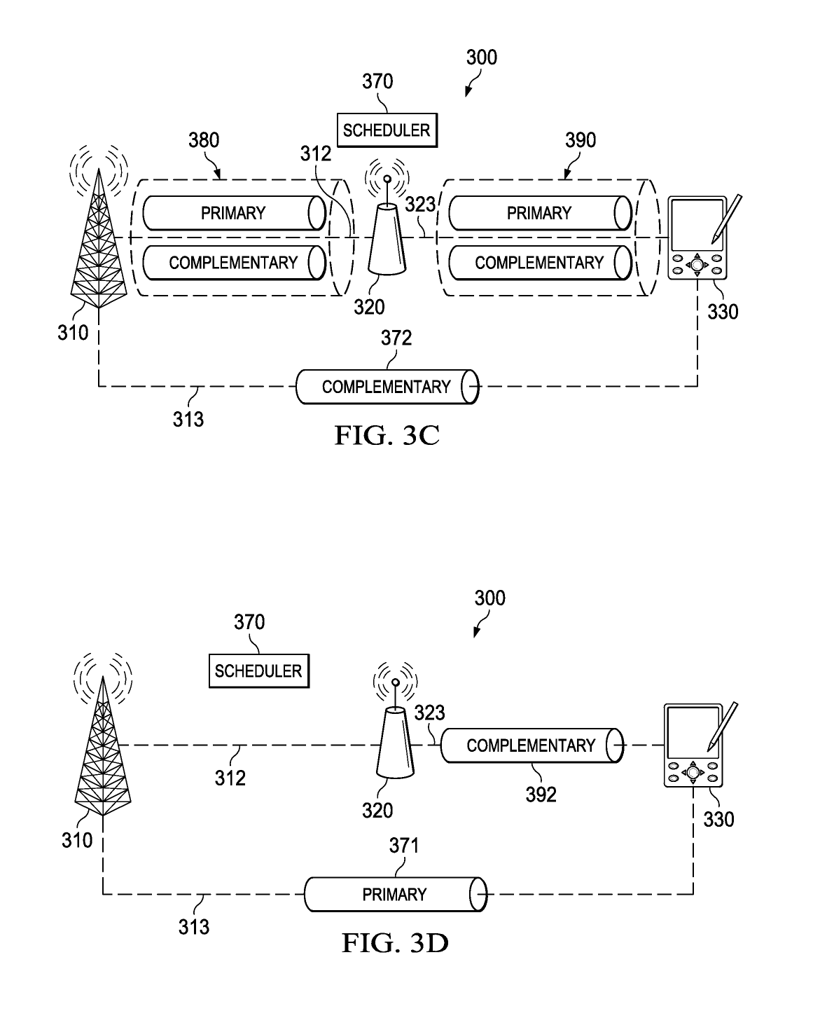

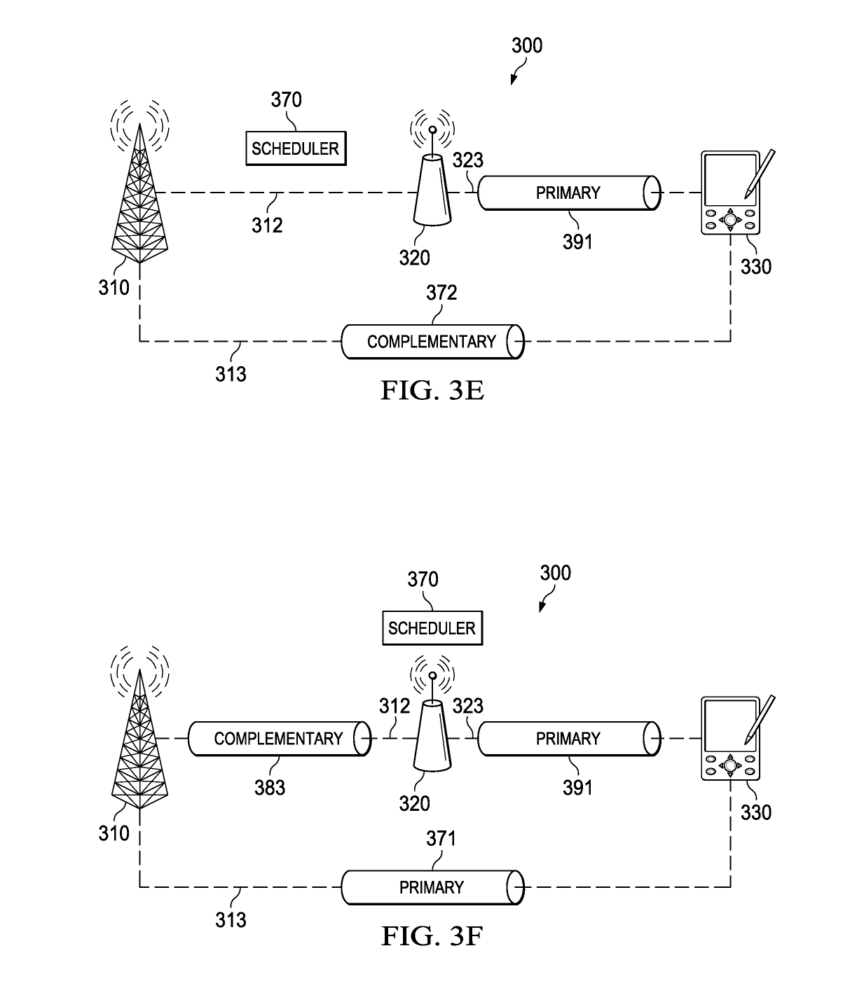

FIG. 4 illustrates an embodiment network 400 for relaying data over primary and complementary spectrum bands. As shown, the embodiment network 400 includes a base station 410 and a plurality of relay stations 420 adapted to provide wireless access to a plurality of UEs 430. In this example, the complementary band includes higher carrier frequencies than the primary band, and the base station 410 communicates over the primary band within the region 401, and at least partially over the complementary band within the region 402. The relays 420 facilitate wireless access within the regions 425 by relaying signals from the base station 410 to the UEs 430 (and vice versa) over the primary band, the complementary band, or both. The network 400 can have various different primary and complementary band configurations. As demonstrated by FIG. 5, the embodiment network 400 may be adapted to transport dual-spectrum wireless transmissions between the base station 410 and the relay stations 420, to transport single-spectrum wireless transmissions between the base station 410 and the UEs 430 over the primary band, and to transport single-spectrum wireless transmissions between the relay stations 420 and the UEs 430 over the complementary band.

Other configurations are also available. For example, the base station 410 may be adapted to perform single-spectrum wireless transmissions to the relay stations 420 over the complementary band, and to perform single-spectrum wireless transmissions over the complementary band to cell-center devices (e.g., relays, UEs, etc.) positioned within the region 402, and perform single-spectrum wireless transmissions over the primary band to cell-edge devices positioned outside the region 402. In another embodiment, the base station 410 may be adapted to perform dual-spectrum wireless transmissions to cell-center devices, and to perform single-spectrum wireless transmissions over the primary band to cell-edge devices. Those of ordinary skill in the art will appreciate that these are merely some of the many possible configurations for the network 400.

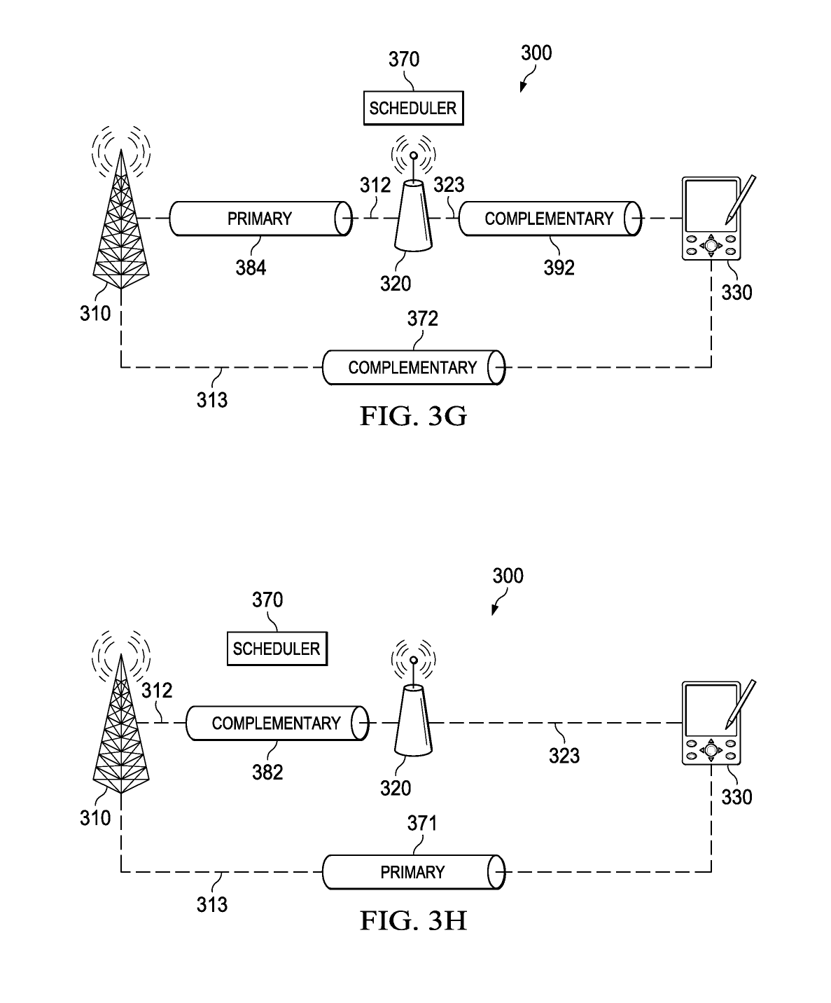

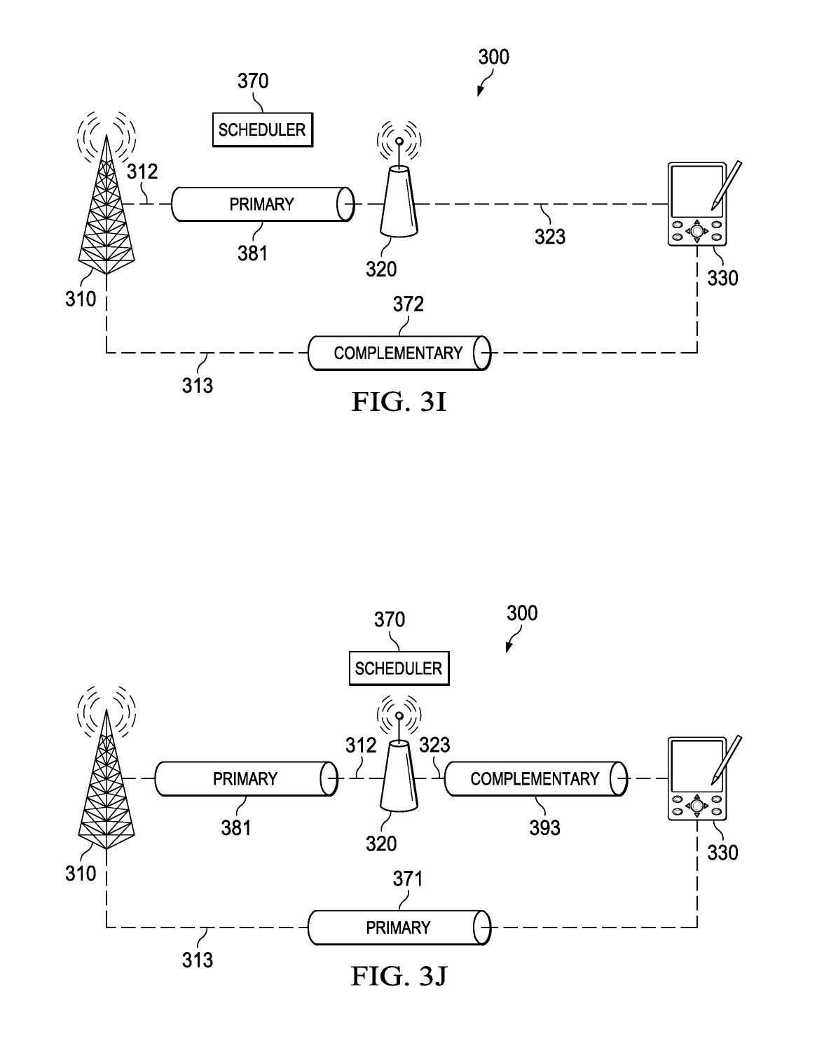

Conversely, the primary band may provide a comparatively smaller coverage region than the complementary band when the complementary band includes lower carrier frequencies than the primary band. FIG. 6 illustrates an embodiment network 600 for relaying data over primary and complementary spectrum bands. As shown, the embodiment network 600 includes a base station 610 and a plurality of relay stations 620 adapted to provide wireless access to a plurality of UEs 630. In this example, the complementary band includes lower carrier frequencies than the primary band, and the base station 610 communicates over the complementary band within the region 601, and at least partially over the primary band within the region 602. The relays 620 are configured similar to the relays 420 in that the relays 620 facilitate wireless access within their respective regions 625 by relaying signals between the base station 610 and the UEs 630. The network 600 can have various different primary and complementary band configurations. As demonstrated by FIG. 7, the embodiment network 600 may be adapted to transport dual-spectrum wireless transmissions between the base station 610 and the relay stations 620, to transport single-spectrum wireless transmissions between the base station 610 and the UEs 630 over the complementary band, and to transport single-spectrum wireless transmissions between the relay stations 620 and the UEs 630 over the primary band. Those of ordinary skill in the art will appreciate that this is merely one of many possible configurations for the network 600.

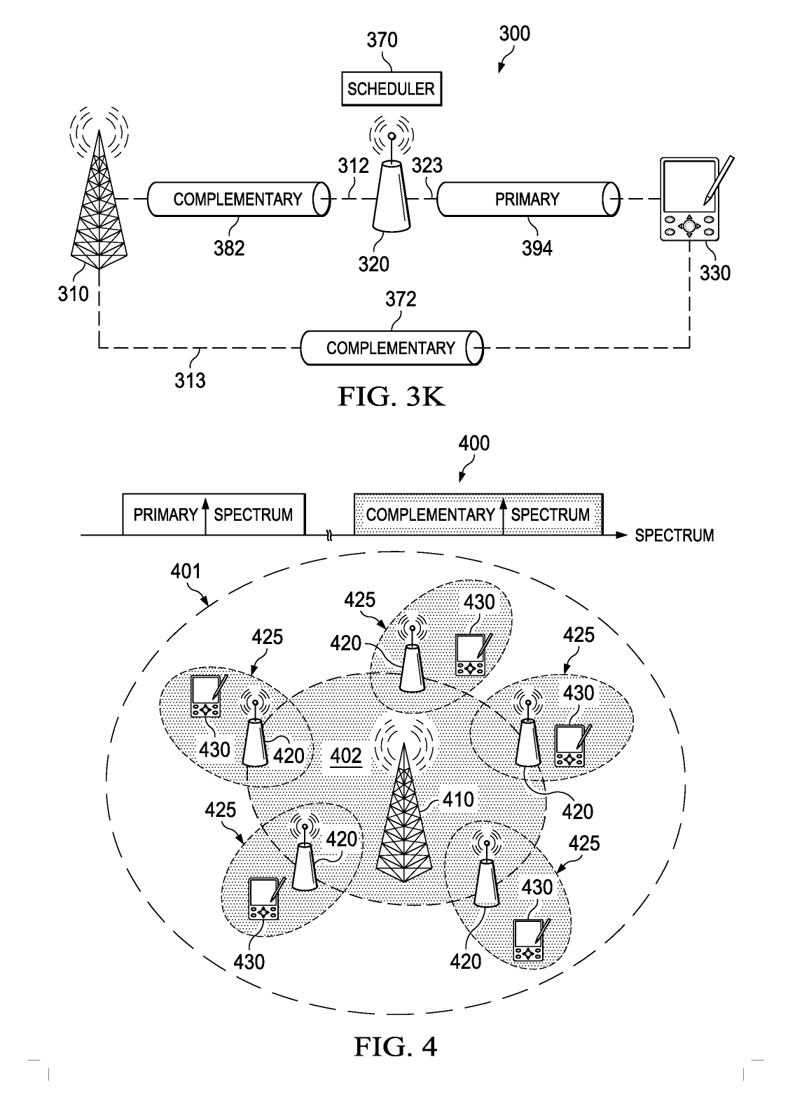

As yet another example, there may be two complementary bands straddling a primary band. FIG. 8 illustrates an embodiment network 800 for relaying data over primary and complementary spectrum bands. As shown, the first complementary band (complementary spectrum 1) includes frequencies that are lower than the primary band, while the second complementary band (complementary spectrum 2) includes frequencies that are higher than the primary band.

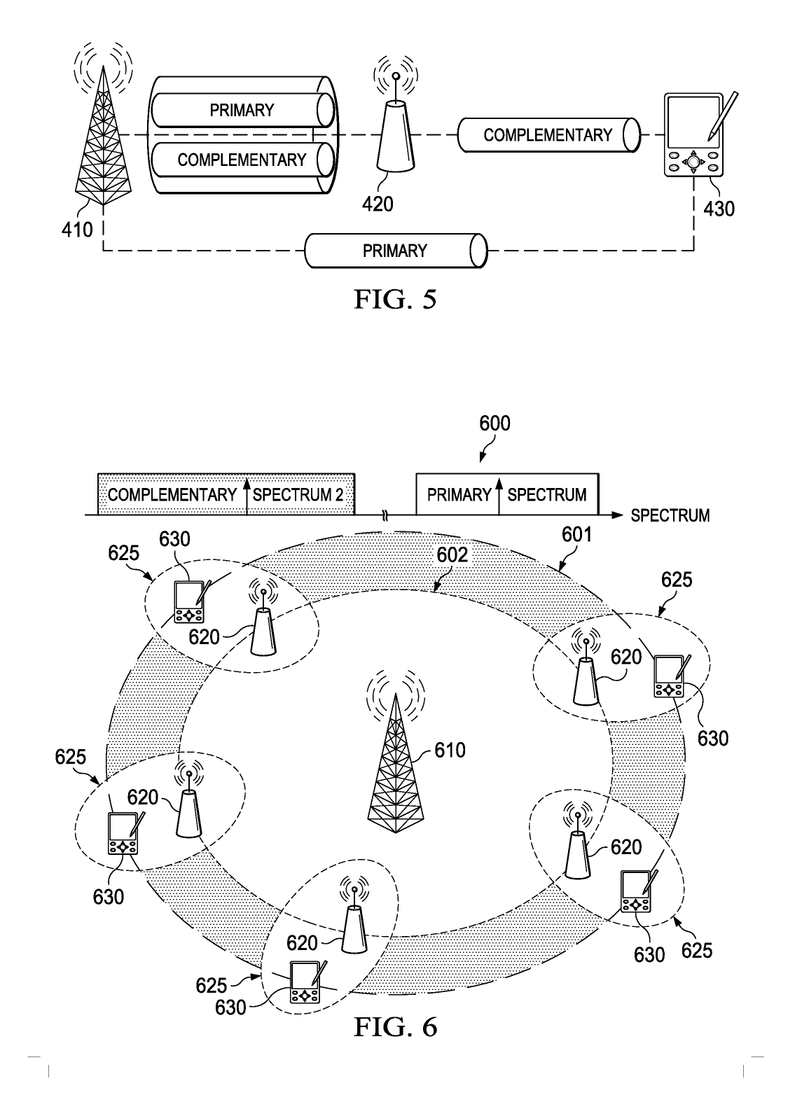

The embodiment network 800 includes a base station 810 and a plurality of relay stations 820, 830 adapted to provide wireless access to a plurality of UEs 829, 839. In this example, the base station 810 communicates over the first complementary band within the region 801, over the primary band within the region 802, and within the second complementary band within the region 801. The relays stations 820 communicate over the primary band within the regions 825, while the relays stations 830 communicate over the second complementary band within the regions 835. This frequency allocation is demonstrated in FIG. 9. Those of ordinary skill in the art will appreciate that this is merely one of many possible configurations for the network 800. Moreover, those of ordinary skill in the art will appreciate that the networks 400, 600, and 800 are merely some of the possible configurations for multi-spectrum relay networks.

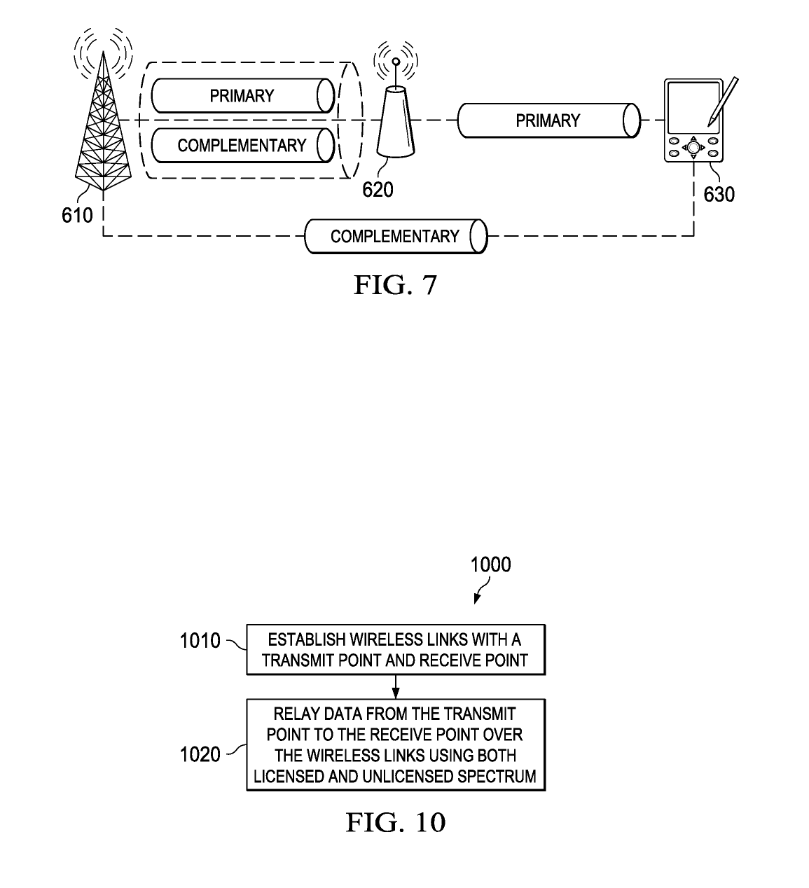

Aspects of this disclosure provide techniques for operating a multi-spectrum relay station adapted to relay data over licensed and unlicensed bands. FIG. 10 illustrates an embodiment method 1000 for relaying data over licensed and unlicensed bands, as might be performed by a relay station. As discussed herein, the term “transmit point” refers to any device adapted to emit a wireless transmission (e.g., a base station, another relay station, a mobile station, etc.), and the term “receive point” refers to any device adapted to receive a wireless transmission (e.g., a base station, another relay station, a mobile station, etc.). As shown, the method 1000 begins at step 1010, where the relay station establishes wireless links with a transmit point and a receive point. Thereafter, the method 1000 proceeds to step 1020, where the relay station relays data from the transmit point to the receive point over the wireless links using both licensed and unlicensed spectrum.

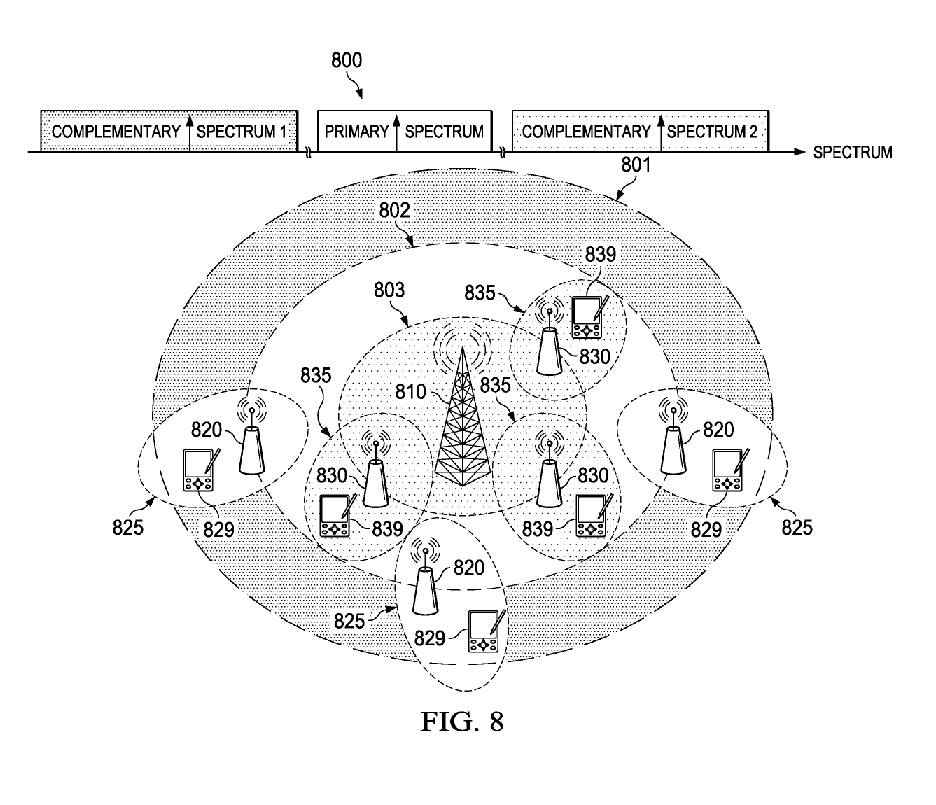

In some embodiments, the relay station may deterministically select the primary or the complementary band for transporting data to the receive point. FIG. 11 illustrates an embodiment method 1100 for relaying data over licensed and unlicensed bands, as might be performed by a relay station. As shown, the method 1100 begins at step 1110, where the relay station establishes wireless links with a transmit point and a receive point. Thereafter, the method 1100 proceeds to step 1120, where the relay station receives a data packet addressed to the receive point from the transmit point. Next, the method 1100 proceeds to step 1130, where the relay station determines whether to transmit the data packet over the primary band. In making this determination, the relay station may consider QoS constraints of the packets and/or conditions on one or both of the primary band and the complimentary band. For example, the relay station may communicate the packet over the primary band when a QoS requirement (e.g., jitter, latency, etc.) exceeds a threshold. As another example, the relay station may communicate the packet over the primary band when a channel condition of the complementary band (e.g., congestion, buffering period, likelihood of collision, etc.) exceeds a threshold.

If the relay station elects to transmit the data packet over the primary band, then the method 1100 proceeds to step 1140, where the relay station transmits the data packet over the primary band. Alternatively, if the relay station decides not to transmit the data packet over the primary band, then the method 1100 proceeds to step 1150, where the relay station transmits the data packet over the complementary band.

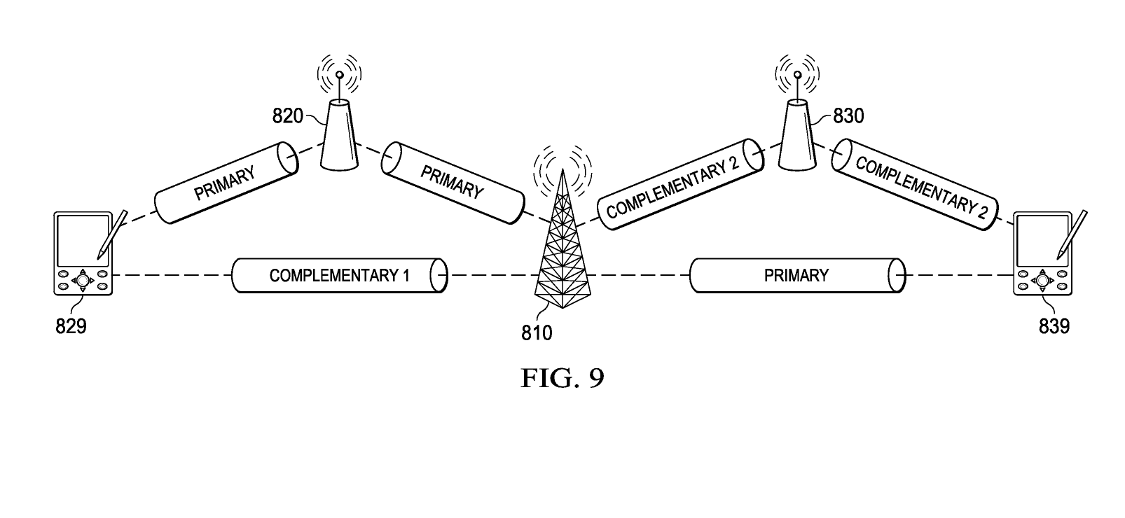

Aspects of this disclosure provide techniques for scheduling data transmissions over licensed and unlicensed bands. FIG. 12 illustrates an embodiment method 1200 for scheduling data over licensed and unlicensed bands, as might be performed by a scheduler. As shown, the method 1200 begins at step 1210, where the scheduler identifies an end-to-end access link adapted to transport traffic over the primary band. Next, the method 1200 proceeds to step 1220, where the scheduler identifies an indirect path extending through a relay station that is adapted to transport traffic at least partially over the complementary band. Thereafter, the method 1200 proceeds to step 1230, where the scheduler assigns traffic to be communicated over the end-to-end access link or the indirect path based on a criteria. In making this determination, the scheduler may consider QoS constraints of the packets and/or conditions on one or both of the primary band and the complimentary band.

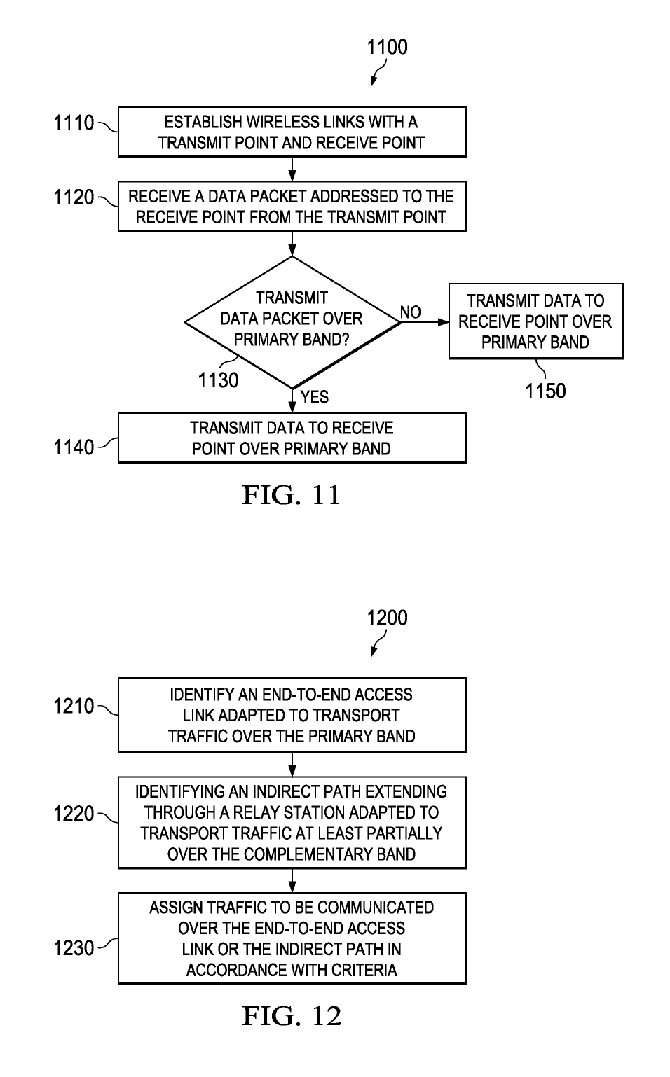

In some embodiments, a base station may be connected to a user equipment via a direct access link, as well as an indirect path that includes a backhaul link extending between the base station and a relay station, and an access link extending between relay station and the UE. In such embodiments, the uplink and downlink traffic may be communicated over different links/paths (e.g., direct link, indirect path) via different bands depending on the characteristics of the traffic and/or conditions of the channels. FIG. 13 illustrates a method 1300 for dynamically forwarding downlink traffic on direct and indirect paths via wireless transmissions spanning licensed and unlicensed spectrum. As shown, the method 1300 begins with step 1310, where the base station receives a packet destined for a user equipment (UE). Next, the method 1300 proceeds to step 1320, where the base station determines whether the packet is delay sensitive. If so, the base station forwards the packet to the UE over a direct link in a wireless transmission spanning the primary band at step 1330.

If the packet is not delay sensitive, then the method 1300 proceeds to step 1340, where the base sends the packet to a multi-spectrum relay over the primary or complementary band. Next, the method 1300 proceeds to step 1350, where the relay determines whether the packet has a high priority, e.g., the priority of the packet exceeds a threshold. If so, the relay forwards the packet to the UE over in a wireless transmission spanning the primary band at step 1390.

If the packet is not delay sensitive, then the method 1300 proceeds to step 1360, where the relay determines whether or not the packet has a deterministic QoS constraint. If so, the relay forwards the packet to the UE over in a wireless transmission spanning the primary band at step 1390. If the packet does not have a deterministic QoS constraint, then the method 1300 proceeds to step 1370, where the relay determines whether or not the complementary band is capable of satisfying a statistical QoS constraint of the packet. If so, the relay forwards the packet to the UE over in a wireless transmission spanning the complementary band at step 1380. Otherwise, if the complementary band is incapable of satisfying the statistical QoS constraint of the packet, then the relay forwards the packet to the UE over in a wireless transmission spanning the primary band at step 1390.

A similar technique can be used to transport uplink traffic. For example, the UE may forward delay sensitive traffic directly to the base station in an uplink wireless transmission spanning the primary band, and forward traffic that is not delay sensitive to the relay. Likewise, the relay may forward high priority traffic, or traffic having a deterministic QoS, to the base station over the primary band, while forwarding traffic having a statistical QoS over the complementary band when the complementary band is capable of satisfying the statistical QoS of the traffic.

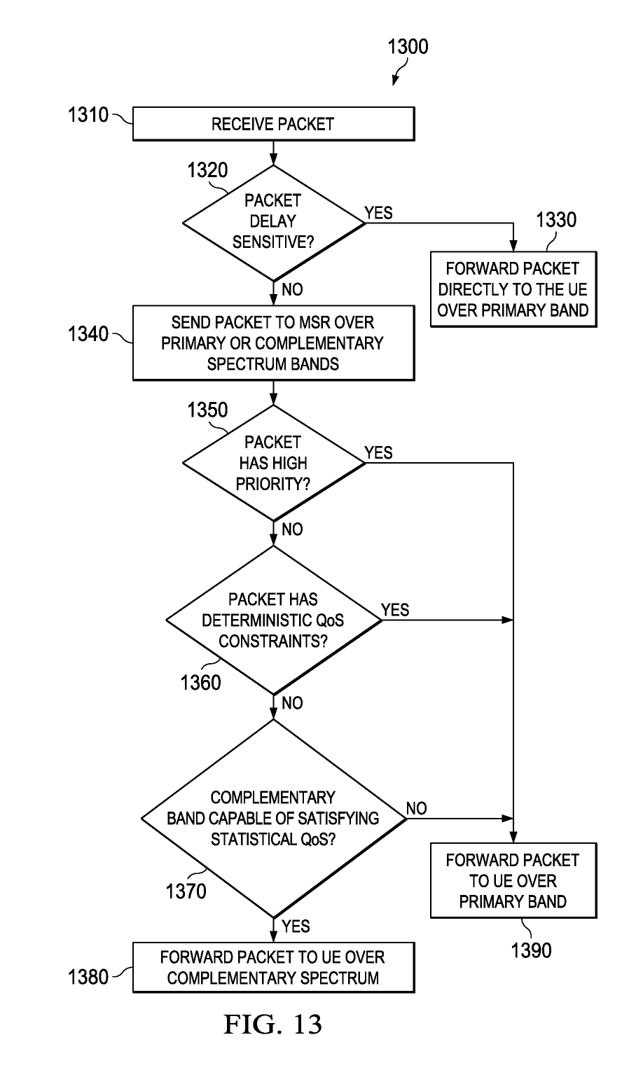

FIG. 14 illustrates a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

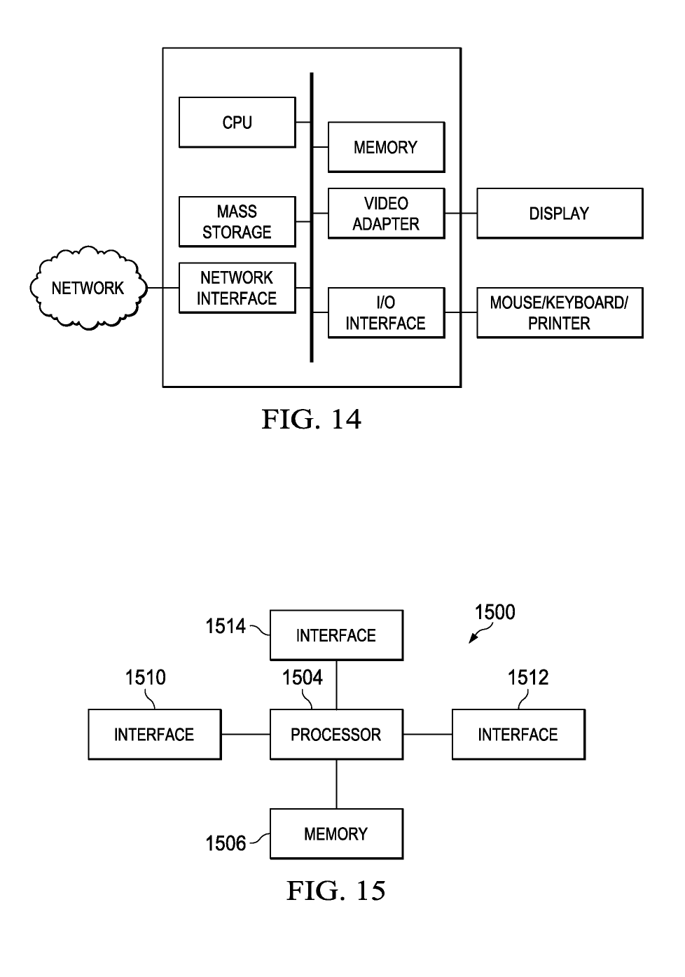

FIG. 15 illustrates a block diagram of an embodiment of a communications device 1500, which may be equivalent to one or more devices (e.g., UEs, NBs, etc.) discussed above. The communications device 1500 may include a processor 1504, a memory 1506, and a plurality of interfaces 1510, 1512, 1514, which may (or may not) be arranged as shown in FIG. 15. The processor 1504 may be any component capable of performing computations and/or other processing related tasks, and the memory 1506 may be any component capable of storing programming and/or instructions for the processor 1504. The interfaces 1510, 1512, 1514 may be any component or collection of components that allows the communications device 1500 to communicate with other devices.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method for operating a multi-spectrum relay, the method comprising:
establishing a first wireless link between a relay station and a transmit point;
establishing a second wireless link between the relay station and a receive point; and
relaying, by the relay station, data from the transmit point to the receive point over the first wireless link and the second wireless link using both licensed and unlicensed spectrum, wherein relaying data from the transmit point to the receive point using both licensed and unlicensed spectrum comprises communicating a first wireless signal that at least partially spans a primary band and a second wireless signal that at least partially spans a complementary band, the primary band being licensed for cellular communication, and the complementary band being reserved for unlicensed communication.

2. The method of claim 1, wherein communicating the first wireless signal and the second wireless signal comprises:
receiving the first wireless signal over the first link from the transmit point, the transmit point being a base station, and the first wireless link being a wireless backhaul link; and
transmitting the second wireless signal over the second wireless link to the receive point, the receive point being a user equipment (UE), and the second wireless link being a wireless access link between the relay station and the UE.

3. The method of claim 2, wherein relaying data from the transmit point to the receive point using both licensed and unlicensed spectrum further comprises:
caching data carried in the first wireless signal after receiving the first wireless signal; and
transmitting the cached data via the second wireless signal when a criteria is satisfied.

4. The method of claim 3, wherein the criteria is satisfied when the base station instructs the relay station to transmit the cached data to the user equipment.

5. The method of claim 3, wherein the second wireless signal comprises a re-transmission of an original data transmission communicated over an end-to-end access link extending between the transmit point and the receive point.

6. The method of claim 5, wherein the criteria is satisfied when the relay station determines that the UE was unsuccessful in decoding the original data transmission in accordance with (ACK/NACK) signaling.

7. The method of claim 6, wherein the ACK/NACK signaling is communicated from the UE to the relay station over the second wireless link in an uplink signal spanning the primary band.

8. The method of claim 6, wherein the ACK/NACK signaling is communicated over the end-to-end access link in an uplink signal spanning the primary band.

9. The method of claim 5, wherein the ACK/NACK signaling is communicated over the primary band.

10. The method of claim 1, wherein the first wireless signal spans portions of both the primary band and the complementary band.

11. The method of claim 1, wherein the second wireless signal spans portions of both the primary band and the complementary band.

12. A relay station comprising:
a processor; and
a non-transitory computer readable storage medium storing programming for execution by the processor, the programming including instructions to:
establish a first wireless link between a relay station and a transmit point;
establish a second wireless link between the relay station and a receive point; and
relay data from the transmit point to the receive point over the first wireless link and the second wireless link using both licensed and unlicensed spectrum, wherein the instructions to relay data from the transmit point to the receive point using both licensed and unlicensed spectrum includes instructions to communicate a first wireless signal that at least partially spans a primary band and a second wireless signal that at least partially spans a complementary band, the primary band being licensed for cellular communication, and the complementary band being reserved for unlicensed communication.

13. A method for operating a multi-spectrum relay, the method comprising:
establishing a wireless link between a relay station and a receive point;
wirelessly receiving a data packet from a transmit point at the relay station, the data packet being addressed to the receive point; and
transmitting, by the relay station, the data packet to the receive point over the wireless link, wherein transmitting the data packet over the wireless link comprises transmitting the data packet over a primary band licensed for cellular communications when a first criteria is satisfied, and transmitting the data packet over a complementary band reserved for unlicensed communications when a second criteria is satisfied.

14. The method of claim 13, wherein the first criteria is satisfied when a priority level of the data packet exceeds a threshold.

15. The method of claim 13, wherein the first criteria is satisfied when a quality of service (QoS) requirement of the data packet exceeds a threshold.

16. The method of claim 13, wherein the second criteria is satisfied when a channel condition of the complementary band exceeds a threshold.

17. A relay station comprising:
a processor; and
a non-transitory computer readable storage medium storing programming for execution by the processor, the programming including instructions to:
establish a wireless link between a relay station and a receive point; and
wirelessly receive a data packet from a transmit point at the relay station, the data packet being addressed to the receive point; and
transmit the data packet to the receive point over the wireless link, wherein the instructions to transmit the data packet over the wireless link include instructions to transmit the data packet over a primary band licensed for cellular communications when a first criteria is satisfied, and to transmit the data packet over a complementary band reserved for unlicensed communications when a second criteria is satisfied.

18. A method for scheduling data, the method comprising:
identifying an end-to-end access link between a base station and a user equipment (UE), the end-to-end link adapted to transport wireless transmissions spanning a primary band licensed cellular communication;
identifying an indirect path between the base station and the UE, the indirect path including at least a backhaul link extending between the base station and a relay station, and an access link extending between the relay station and the UE, wherein at least one of the backhaul link and the access link are configured to transport wireless transmissions spanning a complementary band reserved for unlicensed communication; and
assigning traffic to be communicated over the end-to-end access link or the indirect path in accordance with a criteria.

19. The method of claim 18, wherein assigning the traffic to be communicated over the end-to-end access link or the indirect path in accordance with the criteria comprises:
assigning the traffic to be communicated over the end-to-end link when a quality of service (QoS) requirement of the traffic exceeds a threshold; and
assigning the traffic to be communicated over the indirect path when the QoS requirement of the traffic fails to exceed the threshold.

20. The method of claim 18, wherein assigning the traffic to be communicated over the end-to-end access link or the indirect path in accordance with the criteria comprises:
assigning the traffic to be communicated over the end-to-end link when a link quality of the end-to-end link exceeds a threshold; and
assigning the traffic to be communicated over the indirect path when the link quality of the end-to-end link fails to exceed the threshold.

21. The method of claim 18, wherein assigning the traffic to be communicated over the end-to-end access link or the indirect path in accordance with the criteria comprises:
assigning the traffic to be communicated over the end-to-end link when a link quality of the backhaul link or the access link fails to exceed a threshold; and
assigning the traffic to be communicated over the indirect path when the link quality of the backhaul link or the access link exceeds the threshold.

22. A relay station comprising:
a processor; and
a non-transitory computer readable storage medium storing programming for execution by the processor, the programming including instructions to:
identify an end-to-end access link between a base station and a user equipment (UE), the end-to-end link adapted to transport wireless transmissions spanning a primary band licensed for cellular communication;
identify an indirect path between the base station and the UE, the indirect path including at least a backhaul link extending between the base station and a relay station, and an access link extending between the relay station and the UE, wherein at least one of the backhaul link and the access link are configured to transport wireless transmissions spanning a complementary band reserved for unlicensed communication; and
assign traffic to be communicated over the end-to-end access link or the indirect path in accordance with a criteria.
